(19) United States
(12) Patent Application Publication
(10) Pub. No.: US 2023/0314619 A1
(43) Pub. Date: Oct. 5, 2023

(54) LENS HOLDING MECHANISM, OPTICAL APPARATUS, CONTROL SYSTEM, AND MOVING APPARATUS

(71) Applicant: CANON KABUSHIKI KAISHA, Tokyo (JP)

(72) Inventors: MASAHIKO TSUZUKI, Saitama (JP); KENTO SAITO, Saitama (JP); TATSUYA TANAKA, Tokyo (JP)

(21) Appl. No.: 18/189,090

(22) Filed: Mar. 23, 2023

(30) Foreign Application Priority Data
Mar. 30, 2022 (JP) 2022-055284
Mar. 30, 2022 (JP) 2022-055910

(51) Int. Cl. G01S 17/931; G01S 7/481

(52) U.S. Cl. CPC G01S 17/931; G01S 7/4817; G01S 7/4816

(57) ABSTRACT

A lens holding mechanism capable of pressing a peripheral portion of a lens in an optical axis direction while preventing twisting of an elastic member. Wherein the lens holding mechanism includes a lens barrel configured to house a lens, a pressing ring that is movable with respect to the lens barrel in a direction along an optical axis, a rotary ring configured to rotate about the optical axis to move the pressing ring in the direction along the optical axis, and an elastic member disposed between the lens and the pressing ring, wherein the lens barrel has a rotation restricting portion and a movement restricting portion, wherein, the elastic member is biased to a peripheral portion of the lens in the direction along the optical axis by moving the pressing ring in the direction along the optical axis.

### BACKGROUND

### Field of the Disclosure

The present disclosure relates to a lens holding mechanism, an optical apparatus, a control system, and a moving apparatus.

### Description of the Related Art

Optical apparatuses installed in vehicles such as automobiles include, for example, a sensing device for performing driving support and automatic driving functions and a camera that captures images of the surroundings of an automobile. Optical apparatuses having a sensing function include light detection and ranging (LIDAR) which is a laser radar apparatus that uses laser light to measure the inter-vehicle or other object distance. In recent years, an increasing number of optical apparatuses have been mounted on automobiles as on-board sensors which are used for automatic driving or the like, like LIDAR apparatus.

In general, optical apparatuses used as on-board sensors are exposed to severe environmental changes. On the other hand, for example, a structure in which an elastic member is disposed between a lens and a pressing ring as described in Japanese Patent Laid-Open No. S61-149911 is known as a means for mitigating changes in the position of each lens in response to changes in the environment of an optical apparatus, particularly in response to changes in the ambient temperature.

In the structure of Japanese Patent Laid-Open No. S61-149911, an elastic member is disposed between a lens and a pressing ring as described above. In the structure of Japanese Patent Laid-Open No. S61-149911, the elastic member may be twisted due to the contact resistance between the pressing ring and the elastic member. If the elastic member is twisted, there arises a problem that its biasing force applied to the lens may become uneven and a problem that the elastic member may protrude into an effective light beam region.

Further, as described in Japanese Patent Laid-Open No. S61-149911, even if friction damping sheets are inserted in front of and behind the elastic member, the elastic member may be twisted due to the tightening force of the pressing ring and thus it is difficult to control the amount of twisting of the elastic member.

Equipment such as the optical apparatus described above has a lens barrel that holds optical elements. When optical elements are held in a lens barrel, there is a possibility that if the environmental temperature changes, a gap (looseness) will occur in the optical axis direction due to a difference in the amount of expansion and contraction between the optical elements and the lens barrel which is due to a difference in the linear expansion coefficient therebetween. Looseness that has occurred may change the holding position, which may cause degradation of optical performance and deterioration of parts over time. On-board cameras, LIDAR apparatus, or the like are required to guarantee excellent performance and functions over an entire temperature range in a temperature environment in which temperature changes over a wide range.

Further, on-board cameras usually do not often include an autofocus mechanism for cost reasons. On the other hand, there is a configuration in which a circular annular elastic member is sandwiched and held between a pressing ring and an optical element and is preliminarily crushed to a required amount during assembly at room temperature to provide an elastic force and eliminate looseness at high temperatures. It is thought that driving support and automatic driving functions of automobiles will be required to have higher performance and higher functionality than at present and optical systems of on-board cameras which are the eyes of the automobile will be required to become more sophisticated and highly functional.

It is also thought that, as the optical system of an on-board camera becomes more sophisticated and highly functional as described above, the number of optical elements will increase and the looseness of the pressing ring, the lens barrel, the optical elements, or the like caused by temperature changes may become even greater. Further, for example, when an optical apparatus is externally attached to an automobile, an elastic member may be used for the purpose of drip-proofing and waterproofing in rainy weather. Japanese Patent No. 6192560 discloses a configuration in which both a pressing ring and an elastic member hold an optical element together in a state of being contactable with the optical element. Japanese Patent Laid-Open No. H05-127058 discloses a structure in which an optical element is held by a pressing ring via an elastic member.

Here, in Japanese Patent No. 6192560 and Japanese Patent Laid-Open No. H05-127058, the pressing ring is rotated and screwed in during assembly. With such a configuration, there is a risk that the elastic member may undergo deformation such as torsion or twisting due to friction between the elastic member and both the pressing ring and the optical element. If the optical element is held with the elastic member deformed, the pressing ring will not apply a uniform force to hold the optical element in the lens barrel and thus there is a risk of causing tilting of the optical element or the like, leading to degradation of assembly accuracy, that is, degradation of optical performance.

In addition, if with the elastic member deformed, the environmental temperature changes and parts such as the lens barrel and the optical element expand and contract according to the linear expansion coefficients of their materials, the deformation of the elastic member and the amount of release from a crushed state will partially differ given the looseness that has occurred. As a result, there is a possibility that the optical performance will further deteriorate when the environmental temperature changes.

### SUMMARY OF THE DISCLOSURE

An object of the present disclosure is to provide a lens holding mechanism capable of pressing a peripheral portion of a lens in an optical axis direction while preventing twisting of an elastic member.

A lens holding mechanism according to an aspect of the present disclosure is a lens holding mechanism that holds a lens, the lens holding mechanism including a lens barrel configured to house a lens, a pressing ring configured to be movable with respect to the lens barrel in a direction along an optical axis, a rotary ring configured to rotate about the optical axis to move the pressing ring in the direction along the optical axis, and an elastic member disposed between the lens and the pressing ring, wherein the lens barrel is provided with a rotation restricting portion and a movement restricting portion, the rotation restricting portion being configured to restrict rotation of the pressing ring about the optical axis, and the movement restricting portion being configured to restrict movement of the pressing ring in the direction along the optical axis, and wherein the elastic member is biased to a peripheral portion of the lens in the direction along the optical axis by moving the pressing ring in the direction along the optical axis.

Further features of the present disclosure will become apparent from the following description of exemplary embodiments with reference to the attached drawings.

### BRIEF DESCRIPTION OF THE DRAWINGS

FIG. 1 is a view illustrating an example of a structure of an optical apparatus according to a first embodiment.

FIG. 2 is a cross-sectional view illustrating a structure of a telescope according to the first embodiment.

FIG. 3 is a cross-sectional view of an optical apparatus and its surroundings in a lens unit according to a second embodiment.

FIG. 4 is a schematic cross-sectional view of an optical apparatus according to a third embodiment.

FIG. 5 is an example of an exploded perspective view showing an optical element, an elastic member, and a holding member in FIG. 4.

FIG. 6 is a cross-sectional view showing an example in which the shapes of the optical element and the holding member shown in FIG. 4 are changed.

FIG. 7 is a cross-sectional view showing an example of a lens module according to a fourth embodiment.

FIG. 8 is an exploded perspective view showing an example of an optical element, an elastic member, and a holding member according to the fourth embodiment.

FIG. 9 is a configuration diagram of an on-board system according to a fifth embodiment.

FIG. 10 is a schematic diagram of a vehicle as a moving apparatus including the on-board system according to the fifth embodiment.

FIG. 11 is a flowchart showing an exemplary operation of the on-board system according to the fifth embodiment.

### DESCRIPTION OF THE EMBODIMENTS

Hereinafter, preferred modes for practicing the present disclosure will be described using embodiments and with reference to the accompanying drawings. Repetitive description with reference to each drawing will be omitted or simplified.

### First Embodiment

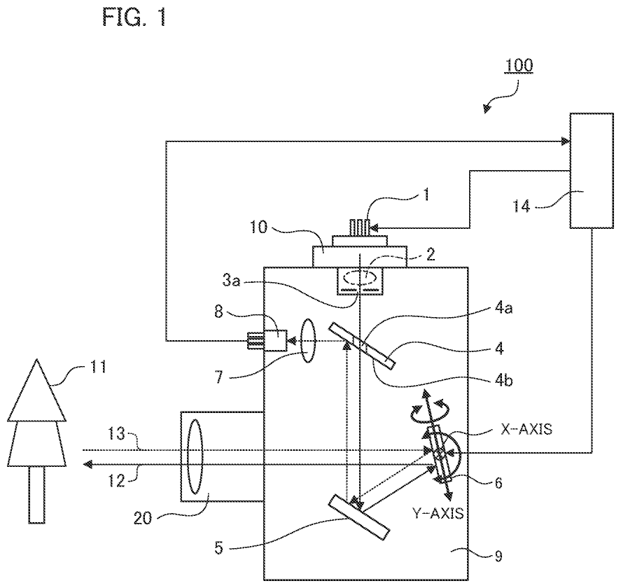

FIG. 1 is a view illustrating a structure of an optical apparatus (an optical instrument) 100 according to a first embodiment. As shown in FIG. 1, the optical apparatus 100 of the first embodiment is a so-called coaxial LIDAR apparatus in which the optical axes of an illumination system that illuminates an object and a receiving system that receives reflected light and scattered light from the object are aligned at a perforated mirror 4.

The optical apparatus 100 according to the first embodiment includes the perforated mirror 4, a fixed mirror 5, a movable mirror 6, a condensing lens 7, a light receiving element 8, a base barrel 9, a light source forming portion (a light projecting portion) 10, a control unit 14, and a telescope 20.

The perforated mirror (a light guide portion) 4 is a mirror that is fixedly held by the base barrel 9 and has a hole 4a (an opening). The perforated mirror 4 can transmit laser light 12 through the hole 4a and reflect it by a reflecting surface 4b. The perforated mirror 4 guides the laser light 12 from the light source forming portion 10 to the fixed mirror 5 and guides the reflected light from the fixed mirror 5 to the condensing lens 7. The fixed mirror 5 is a mirror fixedly held by the base barrel 9. The fixed mirror 5 guides the laser light 12 from the perforated mirror 4 to the movable mirror 6 and guides the reflected light from the movable mirror 6 to the perforated mirror 4.

The movable mirror (a deflecting portion or a scanning portion) 6 is a mirror that is fixedly held by the base barrel 9 and scans the object using illumination light from the light source forming portion 10. The movable mirror 6 is constructed as a two-axis drive mirror that rotates about a Y-axis in FIG. 1 and an X-axis perpendicular to the Y-axis. Examples of the movable mirror 6 include a micro electro-mechanical system (MEMS) mirror. The movable mirror 6 irradiates a target area with the laser light 12 from the fixed mirror 5 via lenses (optical elements) of the telescope 20 and guides the reflected light 13 from an obstacle 11 in the target area to the fixed mirror 5 via the lenses of the telescope 20.

The condensing lens 7 is an optical element (a condensing optical element) that is fixedly held by the base barrel 9 and condenses the laser light 12 from the perforated mirror 4 and guides the condensed laser light 12 to the light receiving element 8. The light receiving element 8 is an element for photoelectrically converting the illumination light from the light source forming portion 10 and outputting a signal. A photodiode (PD), an avalanche photodiode (APD), a single photon avalanche diode (SPAD), or the like is used as the light receiving element 8. The perforated mirror 4, the fixed mirror 5, the movable mirror 6, the condensing lens 7, the light receiving element 8, and the like are incorporated into and housed in the base barrel 9.

The light source forming portion (light projecting portion) 10 includes a light source (a semiconductor laser) 1, a converging lens 2, and a fixed diaphragm 3. The light source 1 is a light source that emits laser light (irradiation light) 12. The converging lens 2 is an optical element that adjusts the beam shape of the laser light 12 from the light source 1 in a target irradiation area. The fixed diaphragm 3 is configured to block unnecessary light included in the laser light 12 that has been emitted from the light source 1 via the converging lens 2 and projects light through its opening 3a.

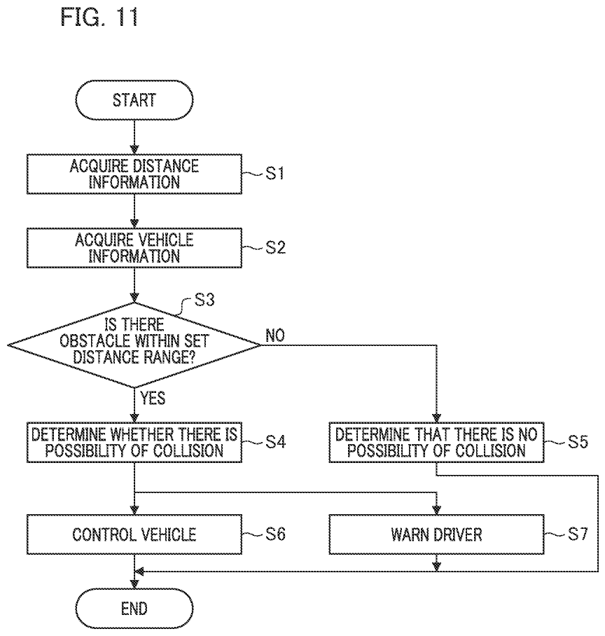

The control unit 14 is made of at least one computer including a CPU, a memory (a storage unit), and the like. The control unit 14 is connected to each component of the optical apparatus 100 via a line. The control unit 14 controls overall operation adjustment and the like of all components of the optical apparatus 100 according to a computer program stored in the memory. This controls the operation of a flowchart shown in FIG. 11 which will be described later. For example, the control unit 14 is preferably configured integrally with the other parts of the optical apparatus 100 but may also be configured separately from the other parts of the optical apparatus 100.

The control unit 14 controls the light source 1, the movable mirror 6, the light receiving element 8, and the like in the first embodiment. Specifically, the control unit 14 drives the light source 1 and the movable mirror 6 with a predetermined drive voltage and drive frequency and measures the waveform of light received by the light receiving element 8 at a specific frequency. Then, the control unit 14 measures the difference between the time when light is received by the light receiving element 8 and the time when light is emitted from the light source 1 or the difference between the phase of a light receiving signal obtained by the light receiving element 8 and the phase of an output signal from the light source 1 and multiplies the difference by the speed of light to determine the distance to the object.

The telescope (a lens holding mechanism) 20 is an optical system that expands the beam diameter of the laser light 12 from the movable mirror 6 and reduces the beam diameter of the reflected light 13 from the obstacle 11 (the object). Specifically, the telescope 20 is an optical system (an afocal system) which includes a plurality of optical elements (lenses), each having refractive power, and has no refractive power as a whole system. The configuration of the telescope 20 will be described later.

Here, the laser light 12 emitted from the light source forming portion 10 of the optical apparatus 100 according to the first embodiment is projected into the base barrel 9 through the opening 3a of the fixed diaphragm 3. The laser light 12 projected through the opening 3a of the fixed diaphragm 3 passes through the hole 4a of the perforated mirror 4, is reflected by the fixed mirror 5, and is irradiated onto the target area by the movable mirror 6.

The laser light 12 emitted from the telescope 20 to the target area is reflected by the obstacle 11 in the target area, passes through the telescope 20 as reflected light 13, and returns to the movable mirror 6. The reflected light 13 reflected by the movable mirror 6 is reflected by the fixed mirror 5. After that, the reflected light 13 is reflected by the reflecting surface 4b of the perforated mirror 4 and guided to the condensing lens 7. The reflected light 13 emitted from the condensing lens 7 is guided to the light receiving element 8. The light receiving element 8 photoelectrically converts the reflected light 13 and outputs a signal.

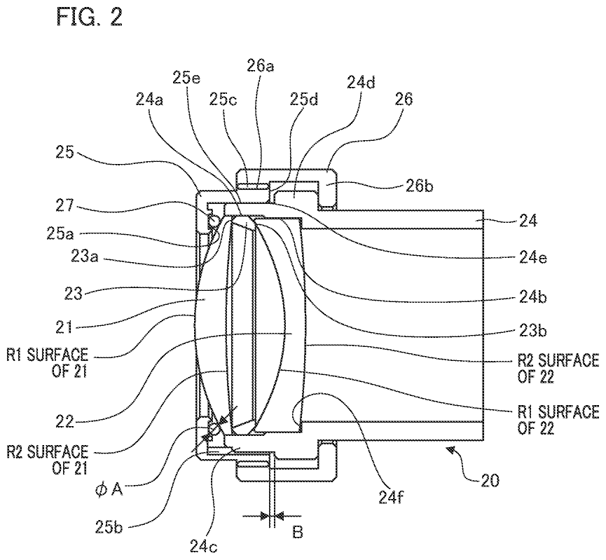

FIG. 2 is an example of a cross-sectional view illustrating the configuration of the telescope 20 according to the first embodiment. The configuration of the telescope 20 will be described below with reference to FIG. 2. The telescope 20 of the first embodiment includes a lens 21, a lens 22, a spacer 23, a fixed lens barrel 24, a pressing ring 25, a rotary ring 26, and an elastic member 27.

Outer diameters of the lens 21 and the spacer 23 are formed smaller than an inner diameter 24a of the fixed lens barrel 24. Specifically, the outer diameters of the lens 21 and the spacer 23 are formed smaller than the inner diameter 24a of the fixed lens barrel 24 by about 10 to 20 μm. An outer diameter of the lens 22 is also formed smaller than an inner diameter 24b of the fixed lens barrel 24. Specifically, the outer diameter of the lens 22 is formed smaller than the inner diameter 24b of the fixed lens barrel 24 by about 10 to 20 μm. Thus, the lens 21, the lens 22, and the spacer 23 can be housed in the fixed lens barrel 24 such that they are arranged in an optical axis direction (a direction along the optical axis).

The spacer 23 has a corner portion 23a and a corner portion 23b that are in line contact respectively with an R2 surface of the lens 21 and an R1 surface of the lens 22 and regulates the eccentricity of the lenses 21 and 22 in a direction orthogonal to the optical axis (in a radial direction) and the interval therebetween in the optical axis direction.

The position of the pressing ring 25 relative to the fixed lens barrel 24 in the optical axis direction is determined by abutting an annular end surface 25d provided on the inner diameter of the pressing ring 25 and a protrusion (a movement restricting portion) 24d provided in an annular shape on the fixed lens barrel 24 together. The protrusion 24d is formed to protrude radially outward by a predetermined amount in the direction orthogonal to the optical axis. The position of the pressing ring 25 in the direction orthogonal to the optical axis is determined by fitting an inner diameter fitting portion 25e of the pressing ring 25 and an outer diameter fitting portion 24e of the fixed lens barrel 24 together.

The elastic member 27 is composed of a member made of rubber or the like and is integrally formed in a circular annular shape (a ring shape). When in contact with a peripheral portion of the lens 21, the elastic member 27 contacts the entire circumference of the lens 21 since the elastic member 27 is integrally formed in a circular annular shape. The elastic member 27 preferably has a circular annular shape integrally formed as described above, but may also have, for example, an annular shape with which a part of the lens 21 is in contact. The elastic member 27 may also be composed of, for example, three separate elastic members that contact the lens 21 at predetermined intervals such as 120 degree intervals.

The elastic member 27 is disposed between the lens 21 and the pressing ring 25. Specifically, the elastic member 27 is held by the pressing ring 25 by arranging the elastic member 27 such that it is fitted in a groove 25a formed in an annular shape on the pressing ring 25. The groove 25a sandwiches and guides the elastic member 27, for example, such that the installation position of the elastic member 27 does not shift (does not move) or the elastic member 27 is not disengaged when the optical apparatus 100 or the telescope 20 is assembled. The groove 25a may be, for example, a recess (including a concavity and a shape equivalent to a concavity) or a semicircular shape and may be any shape as long as the position of the elastic member 27 does not shift when the elastic member 27 is disposed in the groove 25a. The groove 25a may be provided on the lens 21 on the R1 surface side thereof, in which case the groove may not be provided on the pressing ring 25.

Next, a key groove 25b provided on the inner diameter of the pressing ring 25 is fitted with a key portion (a rotation restricting portion) 24c of the fixed lens barrel 24. This restricts rotation of the pressing ring 25 about the optical axis (in a circumferential direction). Further, at this time, a male threaded portion 25c provided on the outer diameter (on an outer peripheral side in the direction orthogonal to the optical axis) of the pressing ring 25 is screwed into a female threaded portion 26a provided in the inner diameter (on an inner peripheral side in the direction orthogonal to the optical axis) of the rotary ring 26. As a result, the pressing ring 25 and the rotary ring 26 are fitted together and fixed. Rotating the rotary ring 26 about the optical axis in this state can move the pressing ring 25 only in the optical axis direction.

When the pressing ring 25 and the fixed lens barrel 24 are fitted together and then the pressing ring 25 and the rotary ring 26 are fitted together when the configuration of the first embodiment is manufactured, a predetermined gap is formed between the protrusion 24d of the fixed lens barrel 24 and the end surface 25d of the pressing ring 25. The predetermined gap is formed with a predetermined width dimension (an interval B) in the optical axis direction. The width dimension of the interval B is a dimension with which the elastic member 27 is in contact with the R1 surface of the lens 21 and the elastic member 27 is not biased against the lens 21. The gap whose width dimension in the optical axis direction is the interval B is formed to satisfy the relationship of the following formula (1) with respect to a cross-sectional dimension ΦA of the elastic member 27.

ΦA>B (1)

As shown in the above formula (1), the interval B has a width dimension smaller than the cross-sectional dimension ΦA of the elastic member 27 described above. Thus, the amount of deformation of the elastic member 27 in the optical axis direction is determined by the interval B which is the width dimension in the optical axis direction.

When the rotary ring 26 is rotated about the optical axis, the pressing ring 25 moves in the optical axis direction and biases the R1 surface of the lens 21 in the optical axis direction with the elastic member 27 interposed therebetween. An annular stopper 26b provided on the inner diameter of the rotary ring 26 comes into contact with the protrusion 24d of the fixed lens barrel 24 in the optical axis direction due to the biasing force of the elastic member 27. When the end surface 25d of the pressing ring 25 is further moved until it abuts against the protrusion 24d of the fixed lens barrel 24, the elastic member 27 is deformed by the interval B and thus the lens 21, the lens 22, and the spacer 23 can be biased against a receiving surface 24f of the fixed lens barrel 24.

Because the interval B is smaller than the cross-sectional dimension ΦA of the elastic member 27, deformation of the elastic member 27 in the optical axis direction can be made substantially uniform even if the rotary ring 26 is rotated about the optical axis and the end surface 25d of the pressing ring 25 is abutted against the protrusion 24d. The pressing ring 25 is movable only in the optical axis direction. Therefore, when the pressing ring 25 is moved in the optical axis direction and the elastic member 27 is biased against the lens 21, the elastic member 27 does not undergo a twist due to torque and comes into contact with the peripheral portion of the lens 21 over the entire circumference, such that it can evenly press the lens 21.

In the first embodiment, for example, an aluminum alloy with a linear expansion coefficient of 26×10⁻⁶/° C. may be used for the fixed lens barrel 24, the pressing ring 25, the rotary ring 26, and the spacer 23. A glass material with a linear expansion coefficient of 7×10⁻⁶/° C. is used for the lenses 21 and 22.

Here, as an example, it is assumed that the thickness of the spacer 23 of an aluminum alloy is 5 mm and the interval between a receiving portion on the R1 surface of the lens 21 of a glass material and a receiving portion on the R2 surface of the lens 22 is 15 mm. The receiving portion on the R1 surface of the lens 21 is a portion of the lens 21 that contacts the elastic member 27 and the receiving portion on the R2 surface of the lens 22 is a portion of the lens 22 that contacts the receiving surface 24f of the fixed lens barrel 24.

At this time, when the temperature changes by 1° C., a thermal expansion difference of about 0.19 μm occurs between the receiving portion on the R1 surface of the lens 21 and the receiving portion on the R2 surface of the lens 22. That is, when the temperature changes by 1° C., a gap difference of about 0.19 μm occurs between the fixed lens barrel 24 and the lenses. For example, in a situation where the optical apparatus 100 is placed in an external environment such as outdoors, looseness (an amount of looseness) of about 11.4 μm occurs in the optical axis direction in an environment such as when the ambient temperature, the temperature inside the optical apparatus 100, or the like at that time rises 60° C. above the temperature when the optical apparatus 100 or the like is assembled. On the other hand, lens deformation of about 11.4 μm occurs in the optical axis direction in an environment where the ambient temperature drops 60° C. below the temperature at the time of assembly as described above.

It is assumed that the optical apparatus 100 according to the first embodiment is used for automatic driving or the like and is applied to a LIDAR apparatus which is a laser irradiation apparatus that uses laser light to measure the inter-vehicle distance. Therefore, the optical apparatus 100 is often exposed to severe environmental changes. Thus, if looseness occurs in the optical axis direction due to a large temperature change as described above, for example, there is a possibility that the lenses 21 and 22 shift in the direction orthogonal to the optical axis (that is, become eccentric). Alternatively, there is a possibility that the lenses 21 and 22 are deformed and aberrations become worse. It is conceivable that these lead to shifts in the projection position and imaging position, reducing the measurement accuracy of the obstacle 11. It is also conceivable that measurement becomes difficult, for example, when measuring minute feature points on the surface of the obstacle 11.

In the first embodiment, the elastic member 27 that is disposed in the groove 25a of the pressing ring 25 and comes into contact with the lens 21 and biases the lens in the optical axis direction is elastically deformed to absorb the looseness in the optical axis direction as described above. That is, in an environment where the ambient temperature rises or drops 60° C. above or below the temperature at the time of assembly of the optical apparatus 100 or the like as described above, the length of the lens changes by about 11.4 μm in the optical axis direction, but the amount of deformation of the lens at this time can be absorbed by the elastic member 27. Regarding the looseness occurring in the direction orthogonal to the optical axis (in the radial direction) of the lenses 21 and 22, when the apparatus is exposed to the environment described above, the protrusion 24d of the fixed lens barrel 24 is abutted against the end surface 25d of the pressing ring 25. Thus, the lenses 21 and 22 are pressed by the spacer 23 and the elastic member 27, such that the relative eccentricity can be alleviated.

In the optical apparatus 100 according to the first embodiment, the elastic member 27 can absorb the looseness of the lenses 21 and 22 or the like incorporated in the telescope 20 in the optical axis direction as described above. That is, as the single elastic member 27 formed in an annular shape presses a plurality of lenses (lenses 21 and 22) and the spacer 23, the elastic member 27 can absorb amounts of looseness of the plurality of lenses and the spacer caused by differences in linear expansion due to temperature changes. Further, the pressing ring 25 can evenly press the peripheral portion of the lens without causing the elastic member 27 to twist due to torque because the pressing ring 25 is movable only in the optical axis direction. Furthermore, the elastic member 27 deforms only by the dimension of the interval B of the predetermined gap at the maximum because the dimension of the interval B is made smaller than the cross-sectional dimension ΦA of the elastic member 27. Thus, deformation of the elastic member 27 in the optical axis direction can be made substantially uniform and the peripheral portion of the lens 21 can be evenly pressed.

The first embodiment has been described with respect to the structure in which the telescope 20 is made of two lenses, but the number of lenses is not limited to two and may be one or more. In the first embodiment, it is also assumed that the present disclosure is applied to a telescope of a LIDAR apparatus that is a laser irradiation apparatus (a laser radar apparatus), but the present disclosure is not limited to this and can be applied to other apparatus other than laser irradiation apparatus.

### Second Embodiment

The first embodiment has been described with respect to an example in which the elastic member 27 is adopted as a portion for fixing the front lens (the lens 21) of the telescope of the LIDAR apparatus. A second embodiment will be described with respect to a mode in which the lens is held by a sensor holder 35 that holds an image pickup element 30 in an imaging lens unit. Matters not mentioned in the second embodiment conform to the first embodiment.

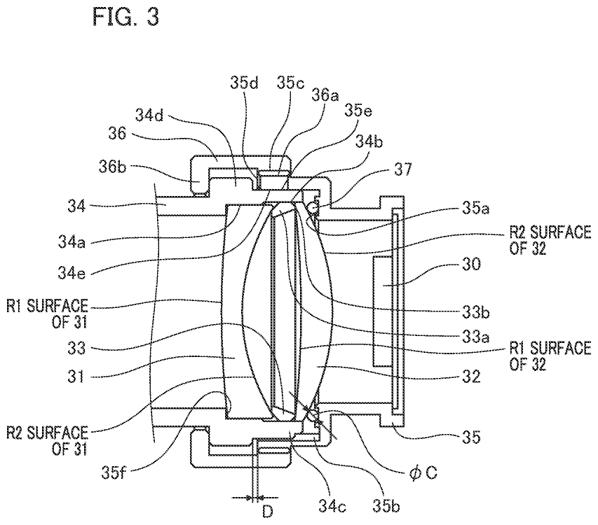

FIG. 3 is a view illustrating a structure of an optical apparatus 100 according to the second embodiment. Specifically, FIG. 3 is a cross-sectional view of the image pickup element 30 and its surroundings in the imaging lens unit (a lens holding mechanism) in the optical apparatus 100.

In FIG. 3, a lens 31, a lens 32, and a spacer 33 are incorporated in a fixed lens barrel 34 and constitute a part of the imaging lens unit. An outer diameter of the lens 31 is formed smaller than an inner diameter 34a of the fixed lens barrel 34. Specifically, the outer diameter of the lens 31 is formed smaller than the inner diameter 34a of the fixed lens barrel 34 by about 10 to 20 μm. Outer diameters of the lens 32 and the spacer 33 are also formed smaller than an inner diameter 34b of the fixed lens barrel 34. Specifically, the outer diameters of the lens 32 and the spacer 33 are formed smaller than the inner diameter 34b of the fixed lens barrel 34 by about 10 to 20 μm. Thus, the lens 31, the lens 32, and the spacer 33 can be housed in the fixed lens barrel 34 such that they are arranged in an optical axis direction.

The spacer 33 has a corner portion 33a and a corner portion 33b that are in line contact respectively with an R2 surface of the lens 31 and an R1 surface of the lens 32 and regulates the eccentricity of the lenses 31 and 32 in a direction orthogonal to the optical axis and the interval therebetween in the optical axis direction.

The image pickup element 30 is fixedly held by the sensor holder 35 and the position of the sensor holder 35 relative to the fixed lens barrel 34 in the optical axis direction is determined by abutting an end surface 35d provided on the sensor holder 35 in an annular shape and an annular protrusion (a movement restricting portion) 34d provided on the inner diameter of the fixed lens barrel 34 together. The protrusion 34d is formed to protrude radially outward by a predetermined amount in the direction orthogonal to the optical axis. The position of the sensor holder 35 in the direction orthogonal to the optical axis is determined by fitting an inner diameter fitting portion 35e of the sensor holder 35 and an outer diameter fitting portion 34e of the fixed lens barrel 34 together.

The elastic member 37 is disposed between the lens 32 and the sensor holder 35. Specifically, the elastic member 37 is held by the sensor holder 35 by arranging the elastic member 37 such that it is fitted in a groove 35a formed in an annular shape on the sensor holder 35. The groove 35a sandwiches and guides the elastic member 37, for example, such that the installation position of the elastic member 27 does not shift (does not move) or the elastic member 27 is not disengaged when the optical apparatus 100 or the imaging lens unit is assembled.

Also, a key groove 35b provided on the inner diameter of the sensor holder 35 is fitted with a key portion (a rotation restricting portion) 34c of the fixed lens barrel 34. This restricts rotation of the sensor holder 35 about the optical axis. Further, at this time, a male threaded portion 35c provided on the outer diameter of the sensor holder 35 is screwed into a female threaded portion 36a provided in the inner diameter of the rotary ring 36. As a result, the sensor holder 35 and the rotary ring 36 are fitted together and fixed. Rotating the rotary ring 36 about the optical axis in this state can move the sensor holder 35 only in the optical axis direction.

When the sensor holder 35 and the fixed lens barrel 34 are fitted together and then the sensor holder 35 and the rotary ring 36 are fitted together when the optical apparatus 100 of the second embodiment is manufactured, a predetermined gap is formed between the protrusion 34d of the fixed lens barrel 34 and the end surface 35d of the sensor holder 35. The predetermined gap is formed with a predetermined width dimension (an interval D) in the optical axis direction. The width dimension of the interval D is a dimension with which the elastic member 37 is in contact with the R2 surface of the lens 32 and the elastic member 37 is not biased against the lens 32. The gap whose width dimension in the optical axis direction is the interval D is formed to satisfy the relationship of the following formula (2) with respect to a cross-sectional dimension ΦC of the elastic member 37.

ΦC>D (2)

As shown in the above formula (2), the interval D has a width dimension smaller than the cross-sectional dimension ΦC of the elastic member 37 described above. Thus, the amount of deformation of the elastic member 37 in the optical axis direction is determined by the interval D which is the width dimension in the optical axis direction.

When the rotary ring 36 is rotated about the optical axis, the sensor holder 35 moves in the optical axis direction and biases the R2 surface of the lens 32 in the optical axis direction with the elastic member 37 interposed therebetween. An annular stopper 36b provided on the inner diameter of the rotary ring 36 comes into contact with the protrusion 34d provided on the fixed lens barrel 34 in the optical axis direction due to the biasing force of the elastic member 37. When the end surface 35d of the sensor holder 35 is further moved until it abuts against the protrusion 34d of the fixed lens barrel 34, the elastic member 37 is deformed by the interval D and thus the lens 32, the lens 31, and the spacer 33 can be biased against a receiving surface 35f of the sensor holder 35.

Because the interval D is smaller than the cross-sectional dimension ΦC of the elastic member 37, deformation of the elastic member 37 in the optical axis direction can be made substantially uniform even if the rotary ring 36 is rotated about the optical axis and the end surface 35d of the sensor holder 35 is abutted against the protrusion 34d. The sensor holder 35 is movable only in the optical axis direction. Therefore, when the sensor holder 35 is moved in the optical axis direction and the elastic member 37 is biased against the lens 32, the elastic member 37 does not undergo a twist due to torque and comes into contact with the peripheral portion of the lens 32 over the entire circumference, such that it can evenly press the lens 32.

In the second embodiment, for example, an aluminum alloy with a linear expansion coefficient of 26×10⁻⁶/° C. may be used for the fixed lens barrel 34, the sensor holder 35, the rotary ring 36, and the spacer 33. A glass material with a linear expansion coefficient of 7×10⁻⁶/° C. is used for the lenses 31 and 32.

Here, as an example, it is assumed that the thickness of the spacer 33 of an aluminum alloy is 5 mm and the interval between a receiving portion on the R1 surface of the lens 31 of a glass material and a receiving portion on the R2 surface of the lens 32 is 15 mm. The receiving portion on the R1 surface of the lens 31 is a portion of the lens 31 that contacts the receiving surface 35f of the sensor holder 35 and the receiving portion on the R2 surface of the lens 32 is a portion of the lens 32 that contacts the elastic member 37.

At this time, when the temperature changes by 1° C., a thermal expansion difference of about 0.19 μm occurs between the receiving portion on the R1 surface of the lens 31 and the receiving portion on the R2 surface of the lens 32. That is, a gap difference of about 0.19 μm occurs between the fixed lens barrel 34 and the lenses. For example, in a situation where the optical apparatus 100 is placed in an external environment such as outdoors, looseness (an amount of looseness) of about 11.4 μm occurs in the optical axis direction in an environment such as when the ambient temperature, the temperature inside the optical apparatus 100, or the like at that time rises 60° C. above the temperature when the optical apparatus 100 or the like is assembled. On the other hand, lens deformation of about 11.4 μm occurs in the optical axis direction in an environment where the ambient temperature drops 60° C. below the temperature at the time of assembly as described above. Similar to the first embodiment, it is assumed that the optical apparatus 100 according to the second embodiment is used for automatic driving or the like and is applied to a LIDAR apparatus which is a laser irradiation apparatus that uses laser light to measure the inter-vehicle distance.

In the second embodiment, the elastic member 37 that is disposed in the groove 35a of the sensor holder 35 and comes into contact with the lens 32 and biases the lens in the optical axis direction is elastically deformed to absorb the looseness in the optical axis direction as described above. That is, in an environment where the ambient temperature rises or drops 60° C. above or below the temperature at the time of assembly of the optical apparatus 100 or the like as described above, the length of the lens changes by about 11.4 μm in the optical axis direction, but the amount of deformation of the lens at this time can be absorbed by the elastic member 37. Regarding the looseness occurring in the direction orthogonal to the optical axis (in the radial direction) of the lenses 31 and 32, when the apparatus is exposed to the environment described above, the protrusion 34d of the fixed lens barrel 34 is abutted against the end surface 35d of the sensor holder. Thus, the lenses 31 and 32 are pressed by the spacer 33 and the elastic member 37, such that the relative eccentricity can be alleviated.

In the optical apparatus 100 according to the second embodiment, the elastic member 37 can absorb the looseness of the lenses 31 and 32 or the like incorporated in the imaging lens unit in the optical axis direction as described above. That is, as the single elastic member 37 formed in an annular shape presses a plurality of lenses (lenses 31 and 32) and the spacer 33, the elastic member 37 can absorb amounts of looseness of the plurality of lenses and the spacer caused by differences in linear expansion due to temperature changes. Further, similar to the first embodiment, the sensor holder 35 can evenly press the peripheral portion of the lens without causing the elastic member 37 to twist due to torque because the sensor holder 35 is movable only in the optical axis direction. Furthermore, the elastic member 37 deforms only by the dimension of the interval D of the predetermined gap at the maximum because the dimension of the interval D is made smaller than the cross-sectional dimension ΦC of the elastic member 37. Thus, deformation of the elastic member 37 in the optical axis direction can be made substantially uniform and the peripheral portion of the lens can be evenly pressed.

The second embodiment has been described with respect to the structure in which the imaging lens unit is made of two lenses, but the number of lenses is not limited to two and may be any of one or more.

### Third Embodiment

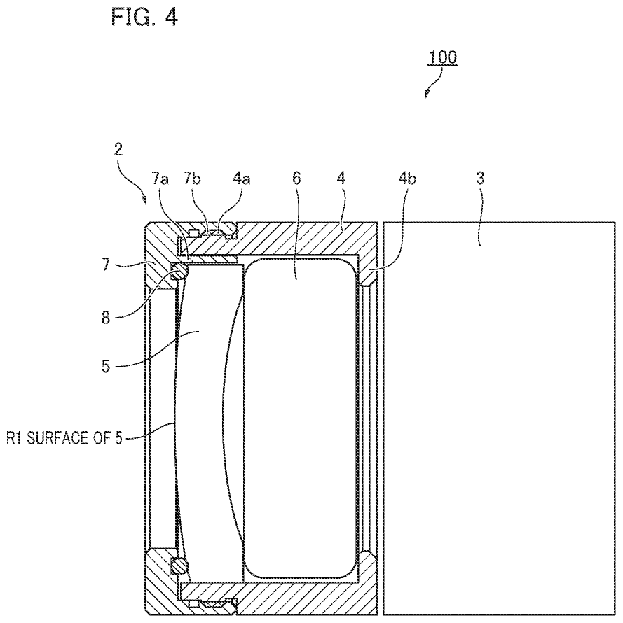

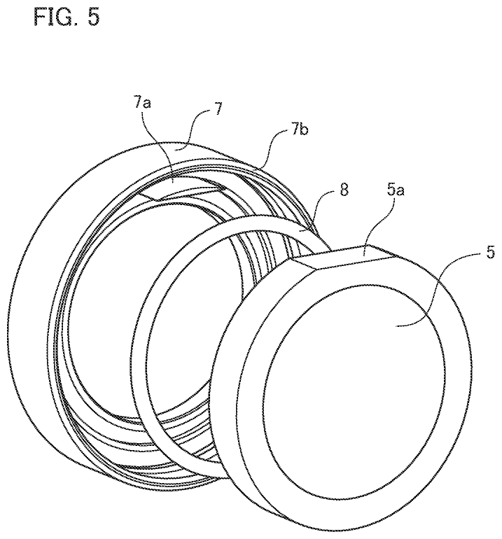

FIG. 4 is a schematic cross-sectional view of an optical apparatus 100 according to a third embodiment. FIG. 5 is an example of an exploded perspective view of a first optical element 5, a holding member 7, and an elastic member 8 according to the third embodiment. The optical apparatus 100 of the third embodiment will be described below with reference to FIGS. 4 and 5.

The optical apparatus 100 of the third embodiment includes a lens module 2, a housing 3, an electrical apparatus (not shown), and a control unit (not shown). Although not shown, the optical apparatus 100 further includes a perforated mirror, a fixed mirror, a movable mirror, a condensing lens, a light receiving element, a light source forming portion (a light projecting portion), and the like. Here, for example, when the optical apparatus 100 is an on-board camera, the lens module 2 functions as an imaging optical system, and when a signal is input to an electrical apparatus (not shown) including an image sensor, environmental information around the automobile vehicle is obtained. The obtained information is used, for example, in a driving support or automatic driving system.

The lens module 2 includes a lens barrel 4, a first optical element 5, another optical element 6, a holding member 7, and an elastic member 8. The holding member 7 holds both the first optical element 5 and the other optical element 6, in which a spacer (not shown) is arranged, into the lens barrel 4. The lens module 2 is held by the housing 3.

The housing 3 houses a perforated mirror, a fixed mirror, a movable mirror, a condensing lens, a light receiving element, a light source forming portion (a light projecting portion), and the like (not shown). The perforated mirror (a light guide portion) is a mirror that is fixedly held by the housing 3 and has a hole (an opening). The perforated mirror can transmit illumination light (for example, laser light) through the hole and reflect it by a reflecting surface. The perforated mirror guides the illumination light from the light source forming portion to the fixed mirror and guides the reflected light from the fixed mirror to the condensing lens. The fixed mirror is a mirror fixedly held by the housing 3. The fixed mirror guides the illumination light from the perforated mirror to the movable mirror and guides the reflected light from the movable mirror to the perforated mirror.

The movable mirror (a deflecting portion or a scanning portion) is a mirror that is fixedly held by the housing 3 and scans the object using illumination light from the light source forming portion. The movable mirror may be configured as a two-axis drive mirror, and for example, a MEMS mirror can be used as the movable mirror. The movable mirror irradiates a target area with the illumination light from the fixed mirror via the optical elements (the first optical element 5 and the other optical element 6) and guides the reflected light from an object in the target area to the fixed mirror via the optical elements.

The condensing lens is an optical element (a condensing optical element) that is fixedly held by the housing 3 and condenses the illumination light from the perforated mirror and guides the condensed illumination light to the light receiving element. The light receiving element is an element for photoelectrically converting the illumination light from the light source forming portion and outputting a signal. A PD, an APD, an SPAD, or the like is used as the light receiving element. The perforated mirror, the fixed mirror, the movable mirror, the condensing lens, the light receiving element, and the like are incorporated into and housed in the housing 3.

The light source forming portion (light projecting portion) includes a light source unit (a semiconductor laser), a converging lens, and a fixed diaphragm. The light source unit is a light source that emits illumination light. The converging lens is an optical element that adjusts the shape (beam shape) of the illumination light from the light source unit in a target irradiation area. The fixed diaphragm is configured to block unnecessary light included in the illumination light that has been emitted from the light source unit via the converging lens and projects light through its opening.

The lens barrel 4 has a male threaded portion 4a and a support portion 4b and houses the first optical element 5 and the other optical element 6. The lens barrel 4 of the third embodiment is made of a metal or resin material. The male threaded portion 4a is a threaded portion formed on a portion of a cylindrical or conical outer surface of the lens barrel 4 along the outer periphery thereof. The support portion 4b is a surface perpendicular to the optical axis (a surface orthogonal to the optical axis) facing one side surface of the other optical element 6 in the optical axis direction and supports the first optical element 5 and the other optical element 6. Here, the support portion 4b is not limited to a surface perpendicular to the optical axis and may be a surface inclined with respect to the optical axis.

The first optical element (lens) 5 has a protrusion receiving portion (an engaged portion) 5a. In the third embodiment, the protrusion receiving portion 5a is configured to have a planar surface (a planar portion) on an outer diameter portion (on an outer peripheral side in the direction orthogonal to the optical axis) of the first optical element 5. Here, one protrusion receiving portion 5a is provided on the first optical element 5 in the third embodiment. However, if a plurality of protrusions 7a which will be described later are formed, a plurality of protrusion receiving portions 5a may be formed according to the number of protrusions 7a that are formed. The first optical element 5 is constructed as a convex lens. However, the first optical element 5 is not limited to this and may be configured with a shape such as that of a concave lens or an aspherical lens. The first optical element 5 is made of a transparent member such as glass or a resin material.

The holding member 7 has a protrusion (an engaging portion) 7a and a female threaded portion 7b. The protrusion 7a is formed to protrude a predetermined length in the optical axis direction and configured to have a planar surface (a planar portion) at a position where it is to abut (engage) the planar portion of the projection receiving portion 5a when the lens module 2 is assembled. The length of the protrusion 7a in the optical axis direction is set such that it does not protrude beyond an end of the first optical element 5 on the other optical element 6 side when the lens module 2 is assembled. Therefore, the protruding length of the protrusion 7a in the optical axis direction can be set arbitrarily as long as it does not protrude beyond the end of the first optical element 5 on the other optical element 6 side and can abut the protrusion receiving portion 5a over an appropriate length.

Although one protrusion 7a is provided on the holding member 7 in the third embodiment, the present disclosure is not limited to this and a plurality of protrusions 7a may be formed. In this case, protrusion receiving portions 5a are formed on the first optical element 5 according to the number and positions of the protrusions 7a. Although the protrusion receiving portion 5a abuts (engages) the protrusion 7a in a radial direction in FIGS. 4 and 5, there may be a slight radial gap between the protrusion receiving portion 5a and the protrusion 7a. That is, the protrusion 7a and the protrusion receiving portion 5a only need to engage each other in the radial direction or the circumferential direction.

The female threaded portion 7b is a threaded portion formed on a portion of a cylindrical or conical inner surface of the holding member 7 along the inner periphery thereof. By screwing together the male threaded portion 4a and the female threaded portion 7b shown in FIG. 4, the holding member 7 is fitted and fixed to the lens barrel 4.

The holding member 7 has a circular annular groove in which the elastic member 8 is to be disposed. The groove of the holding member 7 is formed on the holding member 7 such that it is located radially inward of the surface of the protrusion 7a in the direction orthogonal to the optical axis as shown in FIG. 5. The groove of the holding member 7 is also configured such that its dimension in the radial direction is substantially the same as a cross-sectional diameter of the elastic member 8 in the direction orthogonal to the optical axis (in the radial direction).

The groove of the holding member 7 sandwiches and holds the elastic member 8, for example, such that the installation position of the elastic member 8 does not shift (does not move) or the elastic member 8 is not disengaged when the optical apparatus 100 or the lens module 2 is assembled. The groove may be, for example, a recess (including a concavity and a shape equivalent to a concavity) or a semicircular shape and may be any shape as long as the position of the elastic member 8 does not shift when the elastic member 8 is disposed in the groove. The groove may also be provided on the first optical element 5, in which case the groove may not be provided on the holding member 7. The holding member 7 of the third embodiment is made of a metal or resin material.

The elastic member 8 is made of a rubber material such as silicone rubber and is integrally formed in a circular annular shape (a ring shape). When in contact with a peripheral portion of the first optical element 5, the elastic member 8 contacts the entire circumference of the first optical element 5 since the elastic member 8 is integrally formed in an annular shape. The elastic member 8 preferably has an annular shape integrally formed as described above, but may also have, for example, an annular shape with which a part of the first optical element 5 is in contact. Alternatively, the elastic member 8 may be composed of three elastic members or the like that contact the first optical element 5 at predetermined intervals such as 120 degree intervals. The elastic member 8 is sandwiched and held between the first optical element 5 and the holding member 7 when the lens module 2 is assembled.

Although not shown in FIGS. 4 and 5, the control unit of the optical apparatus 100 according to the third embodiment is made of at least one computer including a CPU, a memory (a storage unit), and the like and is connected to each component of the optical apparatus 100 via a line. The control unit controls overall operation adjustment and the like of all components of the optical apparatus 100 of the third embodiment according to a computer program stored in the memory. This controls the operation of a flowchart shown in FIG. 11 which will be described later, similar to the first embodiment. For example, the control unit is preferably configured integrally with the other parts (for example, the housing 3) of the optical apparatus 100 but may also be configured separately from the other parts of the optical apparatus 100.

The control unit (not shown) controls the light source unit, the movable mirror, the light receiving element, and the like. Specifically, the control unit drives the light source unit and the movable mirror with a predetermined drive voltage and drive frequency and measures the waveform of light received by the light receiving element at a specific frequency. Then, the control unit measures the difference between the time when light is received by the light receiving element and the time when light is emitted from the light source unit or the difference between the phase of a light receiving signal obtained by the light receiving element and the phase of an output signal from the light source unit and multiplies the difference by the speed of light to determine the distance to the object. The control unit of the third embodiment may be the same as the control unit 14 of the first or second embodiment.

Next, a procedure (process) for holding the first optical element 5 and the other optical element 6 in the lens barrel 4 will be described. First, the elastic member 8 is inserted into and sandwiched in the groove of the holding member 7, such that the elastic member 8 is held by the holding member 7. Next, the other optical element 6 is inserted into the lens barrel 4. Next, the first optical element 5 is inserted and the planar portion of the protrusion receiving portion 5a of the first optical element 5 is abutted against the planar portion of the protrusion 7a of the holding member 7.

After that, the female threaded portion 7b of the holding member 7 is screwed with the male threaded portion 4a of the lens barrel 4, such that the holding member 7 and the lens barrel 4 are fixed while the planar portion of the protrusion 7a and the planar portion of the protrusion receiving portion 5a abut (engage) each other in the direction orthogonal to the optical axis (in the radial direction). As a result, the first optical element 5, the holding member 7, and the elastic member 8 rotate as an integral unit when they are rotated in the rotational direction (circumferential direction) about the optical axis.

With the above configuration, the elastic member 8 can be held while preventing torsion or twisting deformation of the elastic member 8 that may be caused by friction between the elastic member 8 and both the first optical element 5 and the holding member 7 with which the elastic member 8 is in contact. Thereby, the holding member 7 can hold (press) the peripheral portion of the first optical element 5 with a uniform force via the elastic member 8.

In the third embodiment, for example, an aluminum alloy with a linear expansion coefficient of 26×10⁻⁶/° C. may be used for the lens barrel 4, the holding member 7, and the spacer (not shown). A glass material with a linear expansion coefficient of 7×10⁻⁶/° C. is used for the first optical element 5 and the other optical element 6.

Here, as an example, it is assumed that there is one spacer with a thickness of 5 mm in the other optical element 6 and the interval between a receiving portion on an R1 surface of the first optical element 5 and the support portion 4b of the lens barrel 4 in the optical axis direction is 25 mm. The receiving portion on the R1 surface of the first optical element 5 is a portion of the first optical element 5 that contacts the elastic member 8.

At this time, when the temperature changes by 1° C., a thermal expansion difference of about 0.29 μm occurs between the receiving portion on the R1 surface of the first optical element 5 and the support portion 4b of the lens barrel 4. That is, a gap difference of about 0.29 μm occurs between the lens barrel 4 and the first optical element 5. Thus, for example, in a situation where the optical apparatus 100 is placed in an external environment such as outdoors, looseness (an amount of looseness) of about 17.4 μm occurs in the optical axis direction in an environment such as when the ambient temperature, the temperature inside the optical apparatus 100, or the like at that time rises 60° C. above the temperature when the optical apparatus 100 or the like is assembled. On the other hand, lens (optical element) deformation of about 17.4 μm occurs in the optical axis direction in an environment where the ambient temperature drops 60° C. below the temperature at the time of assembly as described above.

In the third embodiment, the elastic member 8 that is disposed in the groove of the holding member 7 and comes into contact with the first optical element 5 and presses the first optical element 5 in the optical axis direction is elastically deformed to absorb the looseness in the optical axis direction as described above. That is, in an environment where the ambient temperature rises or drops 60° C. above or below the temperature at the time of assembly of the optical apparatus 100 or the like as described above, the length of the optical element changes by about 11.4 μm in the optical axis direction, but the amount of deformation of the optical element at this time can be absorbed by the elastic member 8.

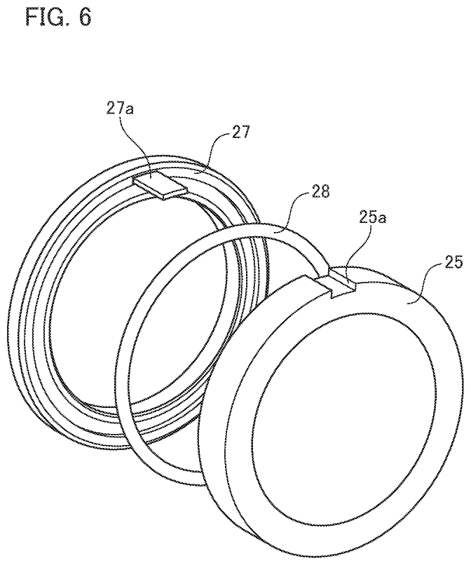

Further, the elastic member 8 is held such that the first optical element 5, the holding member 7, and the elastic member 8 can rotate as an integral unit about the optical axis, such that it is possible to prevent torsion or twisting deformation of the elastic member 8 that may be caused by friction. In the third embodiment, the surface of the protrusion receiving portions 5a that is abutted against the planar surface of the protrusions 7a is also formed into a planar shape as described above, such that the shapes are easy to process. However, the shapes of the protrusion receiving portion 5a and the protrusion 7a are not limited to these and may be, for example, shapes as illustrated in FIG. 6.

FIG. 6 is an exploded perspective view of a holding member 27, an elastic member 28, and a first optical element 25. Components shown in FIG. 6 differ from those shown in FIGS. 4 and 5 in the shapes of a protrusion and a protrusion receiving portion, such that description of portions in common with those described above will be omitted.

As shown in FIG. 6, a protrusion (an engaging portion) 27a of the holding member 27 is formed to have a rectangular cross section in the direction orthogonal to the optical axis. Further, the protrusion 27a is formed to protrude a predetermined length in the optical axis direction. A protrusion receiving portion 25a of the first optical element 25 is also formed on the first optical element 25 in a shape corresponding to the protrusion 27a. For example, the protrusion receiving portion 25a in the example of FIG. 6 is formed to have a concave cross section in the direction orthogonal to the optical axis.

Although the cross-sectional shape of the protrusion 27a in the radial direction is rectangular in FIG. 6, it may also be a shape other than rectangular such as, for example, a triangular shape or a trapezoidal shape. In this case, the protrusion receiving portion 25a has a shape corresponding to the shape of the protrusion 27a. Although the protrusion receiving portion 25a radially abuts (engages) the protrusion 27a in FIG. 6, the depth of the groove of the protrusion receiving portion 25a may be deeper than the thickness of the protrusion 27a. That is, the protrusion 27a and the protrusion receiving portion 25a only need to engage each other in the radial direction or the circumferential direction.

In the optical apparatus 100 of the third embodiment described above, the first optical element 5 (25), the holding member 7 (27), and the elastic member 8 (28) rotate as an integral unit, such that the elastic member 8 can be held while preventing torsion or twisting deformation of the elastic member 8. Thus, it is possible to provide the optical apparatus 100 that can hold the first optical element 5 with a uniform force by the holding member 7 via the elastic member 8.

Although it has been assumed that the optical apparatus 100 according to the third embodiment is applied to an on-board camera used for driving support or automatic driving, the present disclosure is not limited thereto and may be applied to an optical apparatus for an on-board camera.

### Fourth Embodiment

The third embodiment has been described with respect to an example in which the protrusion receiving portion 5a having a shape corresponding to the shape of the protrusion 7a is provided on the outer diameter portion of an optical element (the first optical element 5). A fourth embodiment will be described with respect to a lens module (a lens holding mechanism) in which protrusion receiving portions are provided on portions other than the outer diameter of the optical element (the first optical element 5). Matters not mentioned in the fourth embodiment conform to the third embodiment.

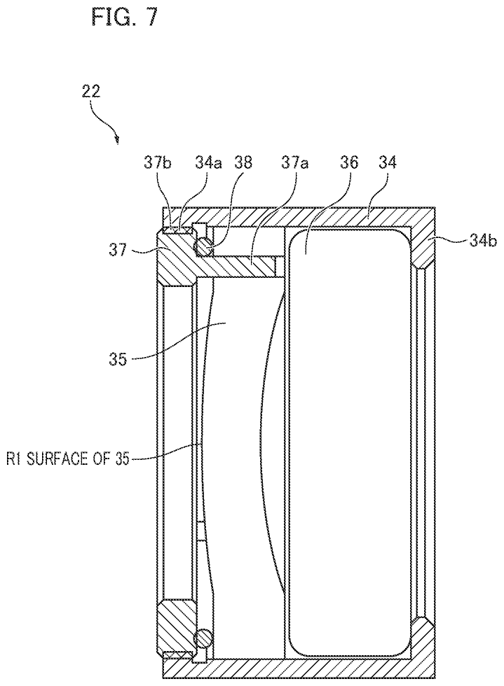

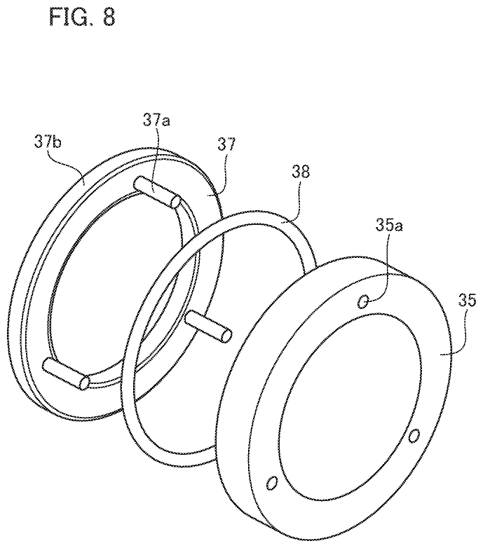

FIG. 7 is a cross-sectional view illustrating a lens module 22 according to the fourth embodiment. FIG. 8 is an example of an exploded perspective view of a first optical element 35, a holding member 37, and an elastic member 38 according to the fourth embodiment.

In the fourth embodiment, the first optical element 35 is constructed as a resin-molded lens. The holding member 37 is also configured as a resin-molded part. By constructing the first optical element 35 and the holding member 37 as resin-molded parts, the manufacturing cost or the cost of parts for the first optical element 35 and the holding member 37 can be reduced and they can be processed into shapes which have a high degree of freedom in processing or the like.

A lens barrel 34 has a female threaded portion 34a and a support portion 34b. The lens barrel 4 of the fourth embodiment is made of a metal or resin material. The female threaded portion 34a is a threaded portion formed on a portion of a cylindrical or conical inner surface of the lens barrel 34 along the inner periphery thereof. The support portion 34b is a surface perpendicular to the optical axis (a surface orthogonal to the optical axis) facing one side surface of another optical element 36 in the optical axis direction and supports the first optical element 35 and the other optical element 36. Here, the support portion 34b is not limited to a surface perpendicular to the optical axis and may be a surface inclined with respect to the optical axis.

The first optical element 35 has protrusion receiving portions (engaged portions) 35a. The protrusion receiving portions 35a are provided between the outer side of the effective diameter of the first optical element 35 and the inner side of the outer diameter thereof. Each protrusion receiving portion 35a is configured in a shape corresponding to each protrusion 37a, and in the fourth embodiment, its cross section in the direction orthogonal to the optical axis is formed in a circular shape. Each protrusion receiving portion 35a is configured as a hole having a size into which a protrusion 37a can be inserted when the lens module 22 is assembled. Although three protrusions 37a are provided on the first optical element 35 in the example shown in FIG. 8, the present disclosure is not limited to this and at least one or more protrusions 37a may be formed. The protrusion receiving portions 35a are formed according to the number and positions of the protrusions 37a. The number of protrusion receiving portions 35a is preferably the same as that of protrusions 37a but may also be larger than that of protrusions 37a.

The holding member 37 has protrusions (engaging portions) 37a and a male threaded portion 37b. Each protrusion 37a has a circular cross section in the direction orthogonal to the optical axis and protrudes a predetermined length in the optical axis direction. That is, each protrusion 37a of the fourth embodiment is configured in a cylindrical shape as shown in FIG. 8.

The length of the protrusion 37a in the optical axis direction is set such that it does not protrude beyond the end of the first optical element 35 on the other optical element 36 side when the lens module 22 is assembled. Therefore, the length of the protrusion 7a in the optical axis direction can be set arbitrarily as long as it does not protrude from the end of the first optical element 35 on the other optical element 36 side. The protrusion receiving portion 35a may not be a through hole and only needs to be formed longer than the protruding length in the optical axis direction of the protrusion 37a.

The male threaded portion 37b is a threaded portion formed on a portion of a cylindrical or conical outer surface of the holding member 37 along the outer periphery thereof. By screwing together the female threaded portion 34a and the male threaded portion 37b shown in FIG. 7, the holding member 37 is fitted and fixed to the lens barrel 34.

The elastic member 38 is made of a rubber material such as silicone rubber and is integrally formed in a circular annular shape (a ring shape). The elastic member 38 of the fourth embodiment is outside the protrusions 37a in the direction orthogonal to the optical axis and is held by the holding member 7 such that an inner surface of the elastic member 38 contacts outer surfaces of the protrusions 37a.

Next, a procedure (process) for holding the first optical element 35 and the other optical element 36 in the lens barrel 34 will be described. First, the elastic member 38 is inserted such that the inner surface of the elastic member 38 contacts the outer surfaces of the protrusions 37a of the holding member 37. Next, the other optical element 36 is inserted into the lens barrel 34. Next, the first optical element 35 is inserted. Next, the protrusions 37a of the holding member 37 holding the elastic member 38 are inserted into the protrusion receiving portions 35a of the first optical element 35. Next, the male threaded portion 37b of the holding member 37 is screwed into the female threaded portion 34a of the lens barrel 34, such that the holding member 37 and the lens barrel 34 are fixed while the protrusions 37a and the protrusion receiving portions 35a abut (engage) each other. As a result, the first optical element 35, the holding member 37, and the elastic member 38 rotate as an integral unit when they are rotated in the rotational direction (circumferential direction) about the optical axis.

With the above configuration, the elastic member 38 can be held while preventing torsion or twisting deformation of the elastic member 38. Accordingly, it is possible to provide the optical apparatus 100 in which the holding member 37 can hold (press) the first optical element 35 with a uniform force via the elastic member 38, similar to the third embodiment.

Although the protrusion receiving portions 35a are circular holes and engage the protrusions 37a in the radial direction in FIG. 8, the protrusion receiving portions 35a may be elongated holes extending in the radial direction. That is, the protrusions 37a and the protrusion receiving portions 35a only need to engage each other in the radial direction or the circumferential direction. Also, although it has been assumed that the optical apparatus 100 according to the third or fourth embodiment is applied to an on-board camera used for driving support or automatic driving, the present disclosure is not limited to this and can be applied to apparatus other than on-board cameras.

### Fifth Embodiment

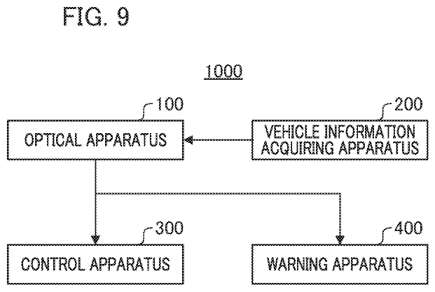

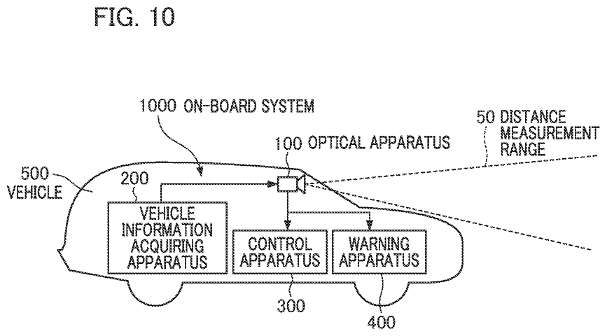

FIG. 9 is a configuration diagram of the optical apparatus 100 according to each of the above embodiments and an on-board system (a driving support apparatus) 1000 including the optical apparatus 100. The on-board system 1000 is held by a movable moving body (a moving apparatus) such as an automobile (a vehicle) and is a control system for supporting the driving (steering) of a vehicle 500 based on distance information of objects such as obstacles and pedestrians around the vehicle acquired by the optical apparatus 100. FIG. 10 is a schematic diagram of the vehicle 500 as a moving apparatus including the on-board system 1000. Although FIG. 10 shows the case where a distance measurement range (a detection range) 50 of the optical apparatus 100 is set in front of the vehicle 500, the distance measurement range 50 may be set in the rear or side of the vehicle 500.

As shown in FIG. 9, the on-board system 1000 includes the optical apparatus 100, a vehicle information acquiring apparatus 200, a control apparatus (a control unit or an electronic control unit (ECU)) 300, and a warning apparatus (a warning unit) 400. The control unit 14 according to the first or second embodiment or the control unit (not shown) according to the third or fourth embodiment included in the optical apparatus 100 in the on-board system 1000 has functions corresponding to a distance acquiring unit (an acquiring unit) and a collision determining unit (a determining unit). However, if necessary, the on-board system 1000 may be provided with a distance acquiring unit and a collision determining unit that are separated from the control units and the distance acquiring unit and the collision determining unit may be provided outside the optical apparatus 100 (for example, inside the vehicle 500). Alternatively, the control apparatus 300 may be used as the control unit 14 according to the first or second embodiment or as the control unit (not shown) according to the third or fourth embodiment.

FIG. 11 is a flowchart showing an exemplary operation of the on-board system 1000 according to a fifth embodiment. The operation of the on-board system 1000 will be described below with reference to the flowchart.

First, in step S1, an object (an obstacle) around the vehicle 500 is illuminated with laser light emitted by the light source forming portion of the optical apparatus 100 and reflected light from the object is received. The control unit acquires distance information of the object based on a signal that the light receiving element (a light receiving unit) outputs upon receiving the reflected light. At this time, the distance acquiring unit functions as a distance information acquiring unit configured to acquire distance information of the object based on the signal from the light receiving element. Here, the distance information may be information relating to a distance from the moving apparatus (the vehicle 500) to the object and may not be the distance itself. In step S2, the vehicle information acquiring apparatus 200 acquires vehicle information including the vehicle speed, yaw rate, steering angle, and the like of the vehicle 500. Then, in step S3, the control unit uses the distance information acquired in step Si and the vehicle information acquired in step S2 to determine whether the distance to the object is within a set distance range that has been set in advance.

Thus, it is possible to determine whether there is an object within the set distance range around the vehicle 500 and to determine the possibility of collision between the vehicle 500 and the object. Steps S1 and S2 may be performed in a reverse order from that described above or may be performed in parallel with each other. The control unit determines that “there is a possibility of collision” if there is an object within the set distance range (step S4) and determines that “there is no possibility of collision” if there is no object within the set distance range (step S5).

Next, upon determining that “there is a possibility of collision,” the control unit reports (transmits) the determination result to the control apparatus 300 and the warning apparatus 400. At this time, the control apparatus 300 controls the vehicle 500 based on the determination result of the control unit (step S6) and the warning apparatus 400 warns the user (the driver or passenger) of the vehicle 500 based on the determination result of the control unit (step S7). At this time, the warning apparatus 400 functions as a warning unit configured to issue a warning according to the distance information of the object. The determination result only needs to be reported to at least one of the control apparatus 300 and the warning apparatus 400.

The control apparatus 300 functions as a control unit configured to be able to control the driving and movement of the vehicle 500 by outputting a control signal to a drive unit (such as an engine or a motor) of the vehicle 500. The control apparatus 300 performs control of the vehicle 500 such as, for example, braking, releasing the accelerator, turning the steering wheel, and generating a control signal for applying a braking force to each wheel to limit the output of the engine or the motor. The warning apparatus 400 warns the user, for example, by issuing a warning sound to the user, displaying warning information on a screen of a car navigation system, or vibrating a seat belt or the steering wheel.

As described above, the on-board system 1000 according to the fifth embodiment can detect and measure an object through the above processing and avoid collision between the vehicle 500 and the object. In particular, by applying the optical apparatus 100 according to each of the above embodiments to the on-board system 1000, it is possible to achieve high accuracy of distance measurement, such that it is possible to perform object detection and collision determination with high accuracy.

Although the on-board system 1000 is applied to driving support (collision damage mitigation) in the fifth embodiment, the on-board system 1000 is not limited to this and can be applied to cruise control (including full-speed range adaptive cruise control), automatic driving, or the like. The on-board system 1000 can be applied not only to vehicles such as automobiles but also to moving bodies such as ships, aircraft, and industrial robots. The on-board system 1000 can be applied not only to moving bodies but also to various apparatuses that use object recognition such as intelligent transportation systems (ITS) and monitoring systems.

The on-board system 1000 or the vehicle 500 may be provided with a reporting apparatus (a reporting unit) that, if the vehicle 500 collides with an obstacle, reports the fact to an on-board system manufacturer (maker), a moving apparatus distributor (dealer), or the like. The reporting apparatus may be, for example, one that transmits information regarding the collision between the vehicle 500 and an obstacle (collision information) to a preset external report destination by e-mail or the like.

By adopting a configuration in which the reporting apparatus automatically reports collision information in this way, it is possible to promptly take measures such as inspections and repairs after a collision has occurred. The report destination of the collision information may be an insurance company, a medical institution, the police, or like or any other party set by the user. The reporting apparatus may also be configured to report not only the collision information but also failure information of each part or consumption information of consumables to the report destination. The presence or absence of a collision may be detected using distance information acquired based on an output from the light receiving element 8 according to the first or second embodiment described above or from the light receiving element (not shown) according to the third or fourth embodiment or may be detected by other detection units (sensors).

A computer program that implements the functions of each embodiment described above may be provided to the optical apparatus 100 or the like via a network or various storage media to perform some or all of the control in each embodiment described above. Then, the computer (or a CPU, an MPU, or the like) of the optical apparatus 100 or the like may read and execute the program. In this case, the program and a storage medium storing the program constitute the present disclosure.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-055910 dated Mar. 30, 2022 and Japanese Patent Application No. 2022-055284 dated Mar. 30, 2022, which is hereby incorporated by reference wherein in its entirety.

What is claimed is:

1. A lens holding mechanism comprising:
a lens barrel configured to house a lens;
a pressing ring configured to be movable with respect to the lens barrel in a direction along an optical axis;
a rotary ring configured to rotate about the optical axis to move the pressing ring in the direction along the optical axis; and
an elastic member disposed between the lens and the pressing ring,
wherein the lens barrel is provided with a rotation restricting portion and a movement restricting portion, the rotation restricting portion being configured to restrict rotation of the pressing ring about the optical axis, and the movement restricting portion being configured to restrict movement of the pressing ring in the direction along the optical axis, and
wherein the elastic member is biased to a peripheral portion of the lens in the direction along the optical axis by moving the pressing ring in the direction along the optical axis.

2. The lens holding mechanism according to claim 1, wherein the elastic member is held by the pressing ring by fitting into a recess formed on the pressing ring.

3. The lens holding mechanism according to claim 1, wherein the pressing ring and the rotary ring are screwed together.

4. A lens holding mechanism comprising:
a lens barrel configured to house a lens;
a sensor holder configured to fixedly hold an image pickup element and to be movable with respect to the lens barrel in a direction along an optical axis;
a rotary ring configured to rotate about the optical axis to allow the sensor holder to move in the direction along the optical axis; and
an elastic member disposed between the lens and the sensor holder,
wherein the lens barrel is provided with a rotation restricting portion and a movement restricting portion, the rotation restricting portion being configured to restrict rotation of the sensor holder about the optical axis, and the movement restricting portion being configured to restrict movement of the sensor holder in the direction along the optical axis, and
wherein the elastic member is biased to a peripheral portion of the lens in the direction along the optical axis by moving the sensor holder in the direction along the optical axis.

5. The lens holding mechanism according to claim 4, wherein the elastic member is held by the sensor holder by fitting into a recess formed on the sensor holder.

6. The lens holding mechanism according to claim 4, wherein the sensor holder and the rotary ring are screwed together.

7. An optical apparatus comprising:
a scanning unit configured to scan an object using illumination light from a light source; and
the lens holding mechanism according to claim 1,
wherein reflected light from the object illuminated by the scanning unit is guided to a light receiving element via the lens.

8. A control system comprising:
the optical apparatus according to claim 7; and
a distance acquiring unit configured to acquire distance information of the object based on a signal from the light receiving element.

9. The control system according to claim 8, further comprising a control apparatus configured to control driving of a moving apparatus based on the distance information of the object.

10. The control system according to claim 8, further comprising a warning apparatus configured to issue a warning according to the distance information of the object.

11. A moving apparatus comprising the optical apparatus according to claim 7, wherein the moving apparatus is movable and configured to hold the optical apparatus.

12. The moving apparatus according to claim 11, further comprising a control unit configured to control driving of the moving apparatus based on the distance information of the object.

13. The moving apparatus according to claim 11, further comprising a warning unit configured to issue a warning according to the distance information of the object.

14. A lens holding mechanism configured comprising:
a lens barrel configured to house a lens,
a holding member configured to be fitted with the lens barrel and press the lens in a direction along an optical axis; and
an elastic member disposed between the lens and the holding member,
wherein an engaging portion is formed on the holding member, and
the lens is formed with an engaged portion configured to engage the engaging portion in a radial direction or a circumferential direction.

15. The lens holding mechanism according to claim 14, wherein the engaging portion and the engaged portion have planar portions, and the planar portion of the engaging portion and the planar portion of the engaged portion engage each other in the radial direction or the circumferential direction.

16. The lens holding mechanism according to claim 14, wherein the engaging portion has a protrusion configured to protrude in the direction along the optical axis.

17. The lens holding mechanism according to claim 14, wherein the elastic member is held by the holding member by fitting into a recess formed on the holding member.

18. The lens holding mechanism according to claim 14, wherein the elastic member is held outside the engaging portion of the holding member in the radial direction.

19. The lens holding mechanism according to claim 14, wherein the elastic member is held inside the engaging portion of the holding member in the radial direction.

20. An optical apparatus comprising:
a scanning unit configured to scan an object using illumination light from a light source; and
the lens holding mechanism according to claim 14,
wherein reflected light from the object illuminated by the scanning unit is guided to a light receiving element via the lens.
